(19) United States
(12) Patent Application Publication
(10) Pub. No.: US 2022/0063975 A1
(43) Pub. Date: Mar. 3, 2022

(54) Bucket Truck Canopy

(71) Applicant: Troy Andritsch, East Troy, WI (US)

(72) Inventor: Troy Andritsch, East Troy, WI (US)

(21) Appl. No.: 17/009,775

(22) Filed: Sep. 2, 2020

(51) Int. Cl. B66F 11/04; B66F 17/00; B66F 13/00

(52) U.S. Cl. CPC B66F 11/046; B66F 2700/09; B66F 13/00; B66F 17/006

(57) ABSTRACT

The bucket truck canopy is a PVC framework with adjustable and removable vinyl windows. The structure is built to attach to the bucket of a bucket truck by means of four clamps. The length of the vinyl windows on the four sides is four to five inches longer than the PVC structure to hang past the lip of the attached bucket and further protect against the weather. All of the vinyl windows are translucent, giving visibility to the worker within the canopy, and are connected to the framework by velcro so the worker may remove them or adjust their positioning as desired. The pitched roof provides shelter from precipitation and is held in place by a locking mechanism. All elements of the bucket design and locking mechanism are non-flammable and non-conductive to protect the worker inside of the structure.

### BACKGROUND

Construction work is a hazardous land-based job. Some construction site jobs include: building houses, roads, tree forts, workplaces and repair and maintain infrastructures. This work includes many hazardous task and conditions such as working with height, excavation, noise, dust, power tools and equipment. The most common fatalities are caused by the fatal four: falls, being struck by an object, electrocutions, and being caught in between two objects. Construction work has been increasing in developing and undeveloped countries over the past few years. With an increase in this type of work occupational fatalities have increased. There have been no products available as original equipment or as an aftermarket to address this problem.

Bucket trucks are generally used for temporary, flexible access purposes such as maintenance and construction work or by firefighters for emergency access, which distinguishes them from permanent access equipment such as elevators. They are designed to lift limited weights, usually less than a ton, distinguishing them from most types of cranes. They are usually capable of being set up and operated by a single person. There have been no products available as original equipment or as an aftermarket to address this problem either.

There exists a need for a bucket truck canopy that is not being met by any known or disclosed device or system of present.

### SUMMARY OF THE INVENTION

The bucket truck canopy is a PVC framework with adjustable and removable vinyl windows. The structure is built to attach to the bed or to the bucket of a truck by means of four clamps. The length of the vinyl windows on the four sides is four to five inches longer than the PVC structure to hang past the lip of the attached bucket and further protect against the weather. All of the vinyl windows are translucent, giving visibility to the worker within the canopy, and are connected to the framework by hook and loop (Velcro R) so the worker may remove them or adjust their positioning as desired. The pitched roof provides shelter from precipitation and is held in place by a locking mechanism. All elements of the bucket design and locking mechanism are non-flammable and non-conductive to protect the worker inside of the structure.

### BRIEF DESCRIPTION OF THE DRAWINGS

FIG. 1 is a view of the bucket truck canopy in accordance with an embodiment of the present disclosure.

FIG. 2 is a separate view of the pitched roof locking mechanism for the bucket truck canopy in accordance with an embodiment of the present disclosure.

FIG. 3 is a flow chart of a method for protecting a construction worker via a portable truck bed canopy in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘skeleton’ is used to refer to an internal or an external framework of pipe, channel, stick, rod, and other materials and geometries. The term ‘shell,’ refers to a protective casing or covering on an inside or on an outside of the skeleton framework. The term ‘flap’ and ‘flap covered opening,’ refer to a portion of the shell which covers an opening defined therein by hanging over the opening. The term ‘scroll’ refers to an ability to roll up for exposing an opening in the shell and able to scroll out again and cover the opening. The translucent shell refers to both a plexiglass and transparent materials which protect an occupant of the enclosure from rain, wind, and sunlight. The shell is also polarized in embodiments to protect against ultraviolet sunshine. The term ‘enclosure,’ refers to a combination of the skeleton frame and the protective shell.

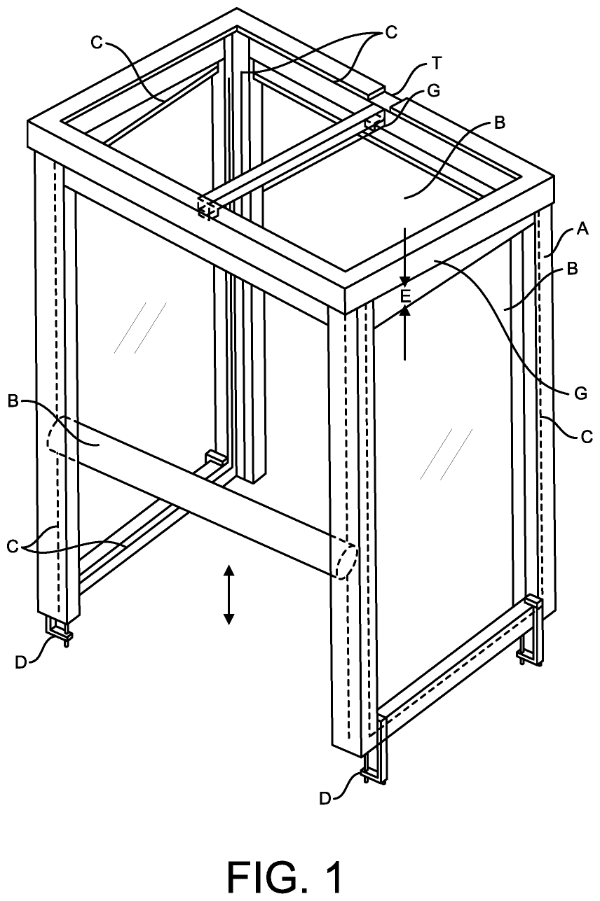

FIG. 1 is a view of the bucket truck canopy in accordance with an embodiment of the present disclosure. At its base are four clamps D which attach to the bucket truck. The PVC frame A is presented, which has five faces: front, back, left, right, and top. The top face is pitched backwards depicted by dimension E, such that precipitation or other liquids descending from above will run off from the top, through the drain trough T and to the back face. All five faces of the PVC structure bear hook and loop (velcro R) lining C to seal the vinyl windows B together. As such, said vinyl windows can easily roll open and shut. On the top face, the vinyl window is further held in place by a locking mechanism G.

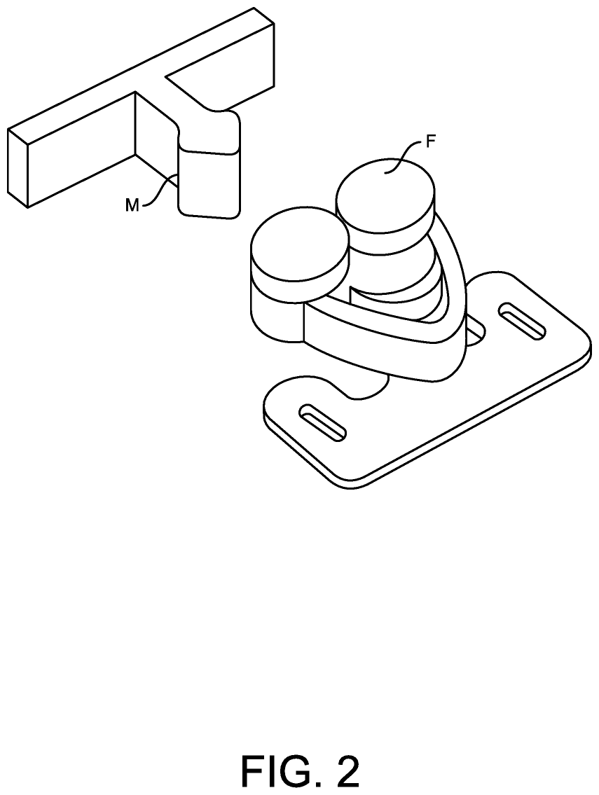

FIG. 2 is a detailed view of the locking mechanism isolated from the bucket truck canopy in accordance with an embodiment of the present disclosure. A locking male piece M is shown which is held into place by shown complementary female piece F. Rollers on the female portion F facilitate the male piece M sliding into and locking the two pieces together and thus fastening two surfaces including the roof pitch E and the roof frame as shown.

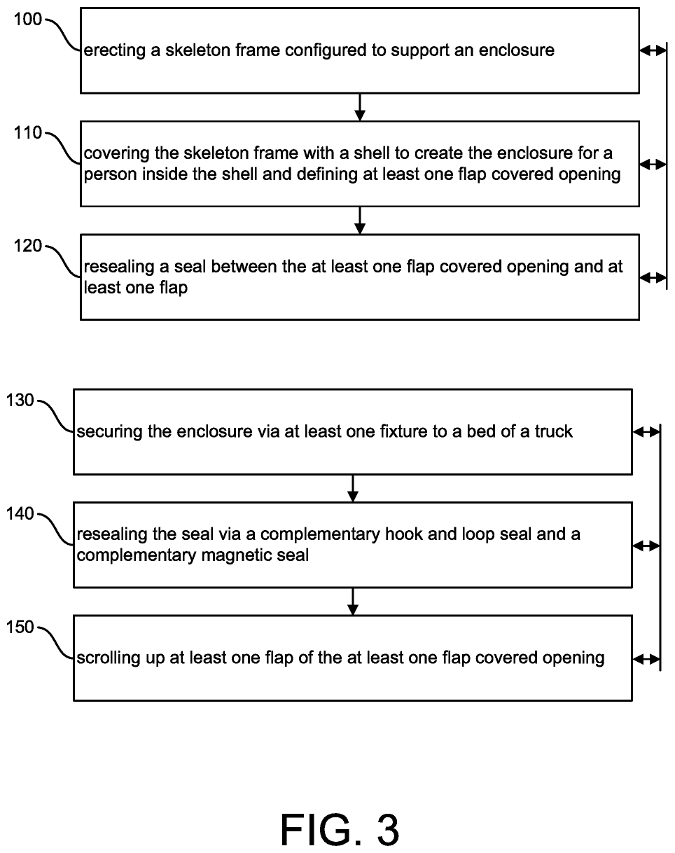

FIG. 3 is a flow chart of a method for protecting a construction worker via a portable truck bed canopy in accordance with an embodiment of the disclosure. The method includes erecting a skeleton frame configured to support an enclosure. The method also includes covering the skeleton frame with a shell to create the enclosure for a person inside the shell and defining at least one flap covered opening. The method additionally includes resealing a seal between the at least one flap covered opening and at least one flap. The method further includes securing the enclosure via at least one fixture to a bed of a truck.

Embodiment of the method include resealing the seal via a complementary hook and loop seal and a complementary magnetic seal. The embodiments also include scrolling up at least one flap of the at least one flap covered opening. The embodiments further include securing the enclosure to the bed of the truck via at least one “C” clamp there between and securing a pitch roof portion of the shell to the skeleton frame via a male-female locking mechanism.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A portable canopy comprising:
a skeleton frame configured to support an enclosure;
a shell configured to the skeleton frame to create the enclosure for a person inside the shell and defining at least one flap covered opening; and
a resealable seal between the at least one flap and the flap covered opening; and

2. The portable canopy of claim 1, wherein the skeleton frame comprises 4 sides and a pitched roof.

3. The portable canopy of claim 1, wherein the skeleton frame comprises a rigid PVC (polyvinyl chloride) structure.

4. The portable canopy of claim 1, wherein the shell comprises a translucent water proof material.

5. The portable canopy of claim 1, wherein a length of the shell is longer than a height of the skeleton frame to provide an overlap of the enclosure to the truck bed.

6. The portable canopy of claim 1, wherein the at least one flap covered opening comprises four sides and a pitched roof.

7. The portable canopy of claim 1, wherein the resealable seal is a hook and loop complementary seal.

8. The portable canopy of claim 1, wherein the resealable seal is a complementary magnetic seal.

9. The portable canopy of claim 1, further comprising at least one fixture to secure the skeleton frame to a bed of a truck.

10. The portable canopy of claim 1, further comprising a pitched roof portion of the skeleton frame.

11. The portable canopy of claim 1, further comprising a pitched roof portion of the shell and a latch mechanism to secure the pitched roof portion to the skeleton frame.

12. The portable canopy of claim 1, wherein a flap portion of the at least one flap covered opening rolls up into a scroll.

13. The portable canopy of claim 1, further comprising a male-female lock mechanism to secure a portion of the shell to a portion of the skeleton frame.

14. A method for protecting a worker from the elements, the method comprising:
erecting a skeleton frame configured to support an enclosure;
covering the skeleton frame with a shell to create the enclosure for a person inside the shell and defining at least one flap covered opening;
resealing a seal between the at least one flap covered opening and at least one flap; and
securing the enclosure via at least one fixture to a bed of a truck.

15. The method of claim 14, further comprising resealing the seal via a complementary hook and loop seal.

16. The method of claim 14, further comprising resealing the seal via a complementary magnetic seal.

17. The method of claim 14, further comprising scrolling up at least one flap of the at least one flap covered opening.

18. The method of claim 14, further comprising securing the enclosure to the bed of the truck via at least one “C” clamp there between.

19. The method of claim 14, further comprising securing a pitch roof portion of the shell to the skeleton frame via a male-female locking mechanism.

20. A portable canopy comprising:
a skeleton frame configured to support an enclosure;
a shell configured to the skeleton frame to create the enclosure for a person inside the shell and defining at least one flap covered opening;
a resealable seal between the at least one flap and the flap covered opening; and
at least one fixture to secure the skeleton frame to a bed of a truck.
